(19) United States
(12) Patent Application Publication
(10) Pub. No.: US 2004/0015521 A1
(43) Pub. Date: Jan. 22, 2004

(54) Non-intrusive, automated upgrading of electronic records

(76) Inventor: Joseph R. Hudicka, Flemington, NJ (US)

Correspondence Address: DARBY & DARBY P.C., 805 Third Avenue, New York, NY, 10022, US

(21) Appl. No.: 10/439,213

(22) Filed: May 14, 2003

Related U.S. Application Data
(60) Provisional application No. 60/416,930, filed on Oct. 8, 2002.
(60) Provisional application No. 60/400,412, filed on Aug. 1, 2002.
(60) Provisional application No. 60/388,159, filed on Jun. 11, 2002.
(60) Provisional application No. 60/381,061, filed on May 15, 2002.

(51) Int. Cl. G06F 12/00

(52) U.S. Cl. 707/200

(57) ABSTRACT

Change-reason functionality is imparted to an existing records management system by providing a software layer that monitors manipulation requests to one or more data fields of the existing records management system; detecting a manipulation request using the software layer; presenting a notification to a user that a change-reason is required for the proposed manipulation request; and in the event that the user has provided the change-reason, selectively updating the one or more data fields.

This patent application claims priority from U.S. Provisional Patent Application Serial No. 60/416,930, filed Oct. 8, 2002 and U.S. Provisional Patent Application Serial No. 60/400,412, filed Aug. 1, 2002, both entitled “Non-intrusive, Automated Upgrading of Electronic Records,” from U.S. Provisional Patent Application Serial No. 60/388,159, filed Jun. 11, 2002, entitled “Rules and Application of Information Metadata,” and from U.S. Provisional Patent Application Serial No. 60/381,061, filed May 15, 2002, entitled “Information Exchange Framework Methodology,” each of which is hereby incorporated by reference as if set forth in their respective entireties herein.

### FIELD OF THE INVENTION

The present invention relates to database management systems, and, more particularly, to improvements in upgrading legacy database management systems.

### BACKGROUND OF THE INVENTION

In the field of data record management, the most challenging requirement is to track the reason for changing an existing data entry. There are audit trail solutions available today but those have not fully addressed this requirement. Rather, they can track, among other things, the data field that was changed, the pre-existing data that was changed, the date of the change and the person who made the change.

It is important, however, to track the reason for making a change to existing data. The Food and Drug Administration, for example, has Regulations codified at 21 Code of Federal Regulations, Part 11 that concern the upgrading of systems that manage electronic records. To comply with regulations such as these, existing systems must be re-built in order to incorporate the change-reason functionality. The cost of doing such a rebuild can be astronomical, and is not an efficient use of a company's resources. What is needed in the art is an alternative technique for incorporating change-reason functionality so as to upgrade existing records management systems. The present invention satisfies these and other needs.

### STATEMENT OF THE INVENTION

The solution of the present invention detects data manipulation requests made by a user through any conventional interface. The manipulation request can be, for example, an attempt to change data in certain data fields followed by pressing the “enter” key or the like to supplant existing data with new data. The user is automatically interrogated (e.g., through a notification such as a pop-up dialog box) that a reason for the change is required. The interrogation can include a selection list or series of radio buttons or checkboxes of common reasons for a change from which the user can select. Failure by the user to provide a reason results in a cancellation of the attempted data manipulation and restoration or preservation of the existing data. On the other hand, if a change-reason is provided by the user, then the attempted manipulation request is accepted. Preferably, the interrogation and the change-reason provided by the user are stored in an audit trail.

In one aspect, the invention comprises a method for imparting a change-reason functionality to an existing records management system, and includes the steps of:

(a) providing a software layer that monitors manipulation requests to one or more data fields of the existing records management system;

(b) detecting a manipulation request using the software layer;

(c) presenting a notification to the user that a change-reason is required for the proposed manipulation request; and

(d) in the event that the user has provided the change-reason, selectively updating the one or more data fields.

The method for imparting a change-reason functionality to an existing records management system can include the further step of preserving an archived history of one or more data field values, thereby enabling the reconstruction of data transactions throughout the data's life cycle.

In further aspects of the invention, the user can be guided as to possible change-reasons for the change to a given data field. The guidance provided to the user can vary depending on the particular data field or the status of the user (e.g., supervisors can be provided with different guidance than clerks).

Further aspects, features and advantages of the invention can be more fully appreciated from the attached Drawing figures and Detailed Description of Certain Exemplary Embodiments.

### BRIEF DESCRIPTION OF THE DRAWING FIGURES

FIG. 1 illustrates a data creation/change request being forwarded from a requesting device toward a database management system through a network cloud;

FIG. 2 illustrates an alert being issued to the requesting device that a reason for the request is missing/required; and

FIG. 3 illustrates a message from a requesting device being passed through to the database management system.

### DETAILED DESCRIPTION OF EXEMPLARY EMBODIMENTS

In a preferred embodiment, the invention is implemented as an add-on (“bolt-on”) solution to existing data collection systems. In this way, the invention can provide a non-intrusive, automated solution to upgrading existing electronic records systems. The present invention can also provide a seamless audit wrapper that is adaptable to any existing data collection system. The present solution provides a single, revision and change control procedure to maintain an audit trail that documents time-sequenced development and modification of electronic records. A data change request can be, for example, to update or delete data, but in either case the existence of the most current view of that data prior that change is preferably maintained within the audit trail.

Due to the independence of the solution described herein from the underlying records management system, companies can rapidly bring their respective systems into compliance with Government regulations and other business-practice guidelines that may exist or later come into existence in a standard, consistent manner.

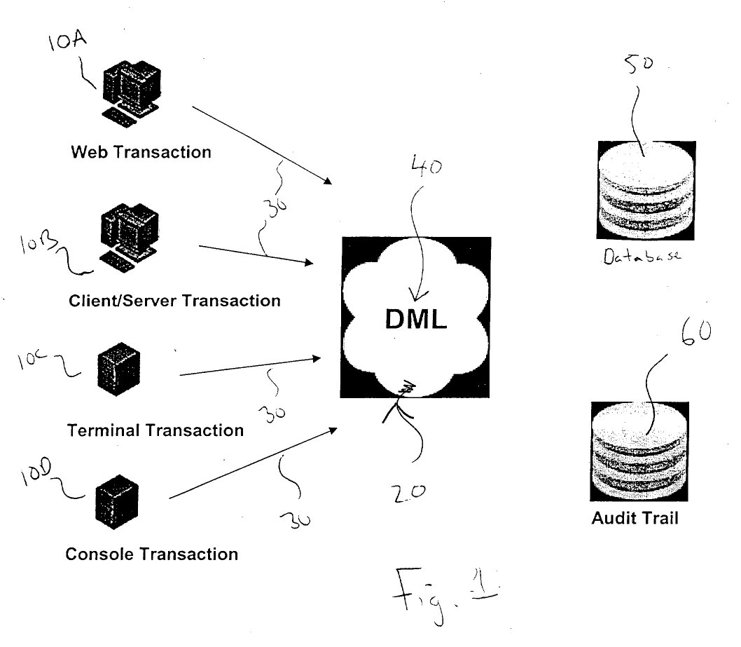

Referring now to FIG. 1, one or more applications from authorized users and platforms create data transactions (Inserts, Updates, Deletes) in a DML (Data Manipulation Language) and submit them to an associated database. Typically, these submissions are in the form of a SQL command, though other languages can be used, as appropriate for the database being manipulated. Generally, such transactions are referred to as “data creation requests” which term is intended to include creation of new data as well as updates and deletions of existing data in the database. Any number of different devices 10 at different locations can be the source of a data creation request. By way of illustration only, such transactions can originate at a client machine 10A connected across the Internet, from a client/server machine 10B, from a terminal 10C, or from a console 10D. The data creation request is forwarded to a network cloud 20 by way of a communication link 30, which may be wired or wireless and which may be permanent or temporary, as is true of all of the communication links discussed herein.

In FIG. 1, the data creation request 40 is received without an explanation for the reason for the change, as is conventional in existing systems. In accordance with an aspect of the invention, a process running at a machine within the network cloud 20, referred to herein as an “audit trail insulation layer,” deems the data creation request 40 as incomplete and prevents that request from being written to the database 50. Accordingly, there is no audit trail to record in a storage device 60 because the proposed data creation request is blocked.

It should be understood that the process or thread that deems the data creation request as incomplete can be resident within a machine in the cloud 20 or in any of the devices 10 and preferably comprises an additional software layer. The determination as to whether a request is complete and suitable for forwarding to the database 50 can be made at the machine where the data creation request originated, if desired, in order to minimize communications (i.e., over links 30 to other machines). To have the determination made at the device 10, all that is required is that the audit trail insulation layer execute within that machine so that it can capture the DML statements and examine them to ensure that a change-reason has been provided. However, the audit trail insulation layer can execute on any one of a variety of machines so long as it can govern proposed updates to the database 50 and entris into the audit trail database 60.

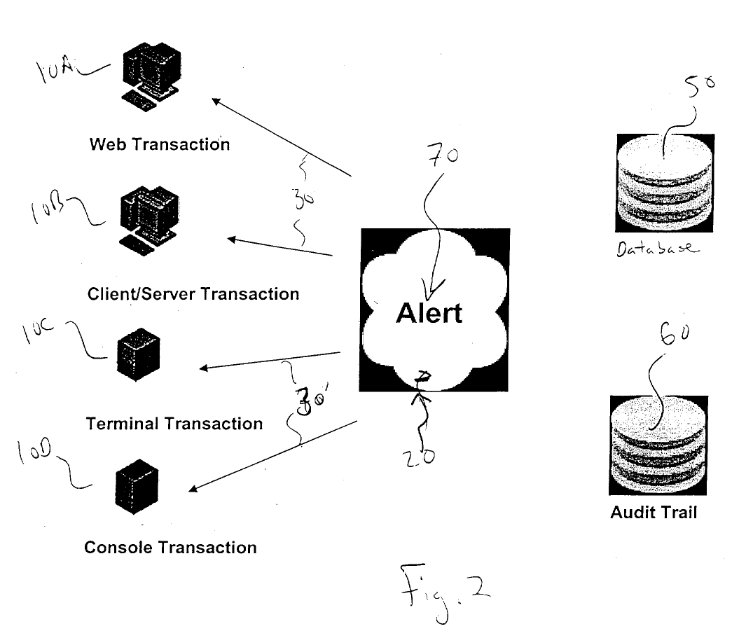

FIG. 2 illustrates an alert 70 being issued to the requesting device 10 over communication links 30′, which may be the same as links 30 or different links. The alert constitutes a notification to the user that a change-reason is required for the proposed manipulation request. The issued alert is displayed at the device 10, or printed on a machine connected thereto, to provide such notice to the user. In the event that the user does not provide a change-reason, the data fields in the database 50 cannot be created, updated or modified. If the audit trail insulation layer is resident on the device 10, the alert 70 is issued on that machine and optionally can be forwarded to one or more other machines to which the device 10 is connected.

On the other hand, if the user provides a change-reason 80 via the device 10 (e.g., over a communication link 30″ (which may be the same as link 30 or 30′)), then one or more data fields within the database 50 can be updated. Updating is permitted in this circumstance because a device in the network cloud 20 (or a software layer or other process or thread configured to review the data creation requests) determines that a change-reason 80 is accompanying the DML statement, namely, the data creation request 40. The change-reason 80 and the data creation request 40 can be combined into a single instruction, and, if so combined, the determination as to whether to permit the database to be updated requires that the combined instruction be parsed to determine whether the change-request 80 is contained therein or not. If both the change-reason 80 and the data creation request 40 have been forwarded by the device 10, then the instruction to update the database 50 is conveyed over a communication link 90 to a database management system. In addition, the illustrated embodiment has the change request forwarded to the storage device 60 (e.g., over communication link 92) in order to create an audit trail of all modifications to the database 50.

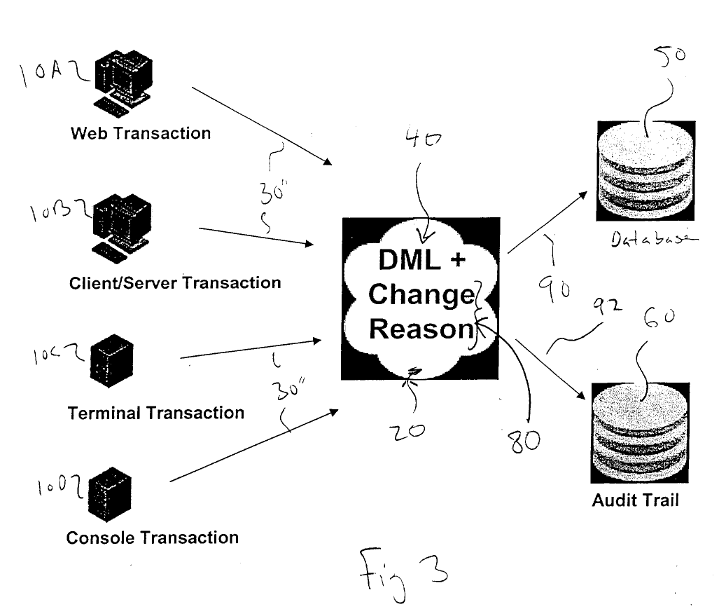

Referring then to FIGS. 1-3, the audit trail insulation layer captures these DML statements and suspends them momentarily, while sending an alert to the user/platform requesting a change-reason, to justify the data transaction in the case of update and deletion requests. The user preferably selects a change-reason from a list or the like and submits the selected reason to the audit trail insulation layer. The audit trail insulation layer can match a previously defined DML statement 40 with a selected change-reason 80 so that the DML transaction can be applied to the database 50 while the change-reason is associated with that transaction and stored in the storage device 60. In this way, legacy databases are supported while compliance with more recent requirements to have a change-reason can be accommodated without reconstructing the underlying database.

The invention has been described in detail with regard to a particular embodiment thereof, but the invention is more broadly defined and is not to be limited to that embodiment but rather is defined by the claims that follow below.

I claim:

1. A method for imparting a change-reason functionality to an existing records management system, comprising the steps of:
(a) providing a software layer that monitors manipulation requests to one or more data fields of the existing records management system;
(b) detecting a manipulation request using the software layer;
(c) presenting a notification to a user that a change-reason is required for the proposed manipulation request; and
(d) in the event that the user has provided the change-reason, selectively updating the one or more data fields.

2. The method of claim 1, including the additional step of preserving an archived history of one or more data field values, thereby enabling the reconstruction of data transactions throughout the data's life cycle.

3. The method of claim 1, including the additional step of guiding the user as to possible change-reasons for the change to a given data field.

4. The method of claim 3, wherein the manipulation request concerns a particular data field in the existing records management system, the method including the additional step of selecting the guidance to provide to the user based on the particular data field.

5. The method of claim 3, wherein the user has a status within the existing records management system, the method including the additional step of selecting the guidance to provide to the user based on the status of the user.

6. The method of claim 5, wherein the status of the user is selected from the group which includes supervisors and clerks.

7. The method of claim 1, including the additional steps of:
capturing the manipulation request in the software layer while the notification is presented; and
releasing the manipulation request in the event that the user has provided the change-reason,
whereby the one or more data fields are selectively updated.

8. The method of claim 1, including the additional step of combining the manipulation request and the change-reason into a single instruction.

9. The method of claim 8, including the additional step of parsing the single instruction to determine whether the change-reason has been provided.
